(19) United States
(12) Patent Application Publication
(10) Pub. No.: US 2025/0193821 A1
(43) Pub. Date: Jun. 12, 2025

(54) HANDLING TIMING ADVANCE IN MULTI-PANEL TX SCENARIO

(71) Applicant: LENOVO (BEIJING) LIMITED, Beijing (CN)

(72) Inventors: Ran YUE, Beijing (CN); Lianhai WU, Beijing (CN); Haiming WANG, Beijing (CN); Bingchao LIU, Beijing (CN); Jing HAN, Beijing (CN)

(21) Appl. No.: 18/844,582

(22) PCT Filed: Mar. 7, 2022
(86) PCT No.: PCT/CN2022/079545

§ 371 Date: Sep. 6, 2024

(51) Int. Cl. H04W 56/00; H04W 74/0833

(52) U.S. Cl. CPC H04W 56/0045; H04W 74/0833

(57) ABSTRACT

Methods and apparatuses for are disclosed. A user equipment (UE) comprises multiple links to a network device, each link is associated with a time alignment (TA), wherein at least one link is un-synchronized and at least one other link is synchronized, the UE comprises a processor; and a transceiver coupled to the processor, wherein the processor is configured to: determine to update the TA for one of the at least one un-synchronized link with the network device; and transmit, via the transceiver, to the network device a request to update the TA for the one un-synchronized link.

### FIELD

The subject matter disclosed herein generally relates to wireless communications, and more particularly relates to methods and apparatuses for handling timing advance in multi-panel TX scenario.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), time alignment or timing advance or timing adjustment (TA), Timing Advance Timer (TAT), Transmit-Receive Point (TRP), Physical Uplink Control Channel (PUCCH), Physical Uplink Shared Channel (PUSCH), reference signal (RS), Medium Access Control (MAC), MAC Control Element (MAC CE), control resource set (CORESET), power headroom (PHR), Physical Downlink Control Channel (PDCCH), Random Access Channel (RACH), Random Access Response (RAR), hybrid automatic repeat-request (HARQ), Channel State Information (CSI), Packet Delay Budget (PDB), Data Radio Bearer (DRB), Beam Failure Recovery (BFR).

TA, which can represent time alignment or timing advance or timing adjustment, is used to adjust the uplink frame timing relative to the downlink frame timing. A TA value, which can be the amount of timing adjustment, depends on the propaganda delay of the signal from the gNB to the UE.

A cell may have multiple (e.g. two) TRPs. A UE may transmit UL signals (e.g. PUSCH transmission and/or PUCCH transmission) to multiple TRPs. In NR Release 17, the multiple TRPs are limited to two TRPs.

To extend the cell coverage, multiple TRPs are likely to be put in different locations within the cell. In this condition, the TA value from a UE to one of multiple TRPs and the TA value from the UE to another of the multiple TRPs (e.g. two TRPs) will be different significantly. It means that, the UE should transmit a UL signal to one TRP of a cell by using one TA value and transmit the same UL signal or another UL signal to another TRP of the cell by using another TA value.

So, the UE needs to maintain at least two TA values for a cell having multiple (e.g. two) TRPs that are located differently. When the UE transmits UL signals to multiple (e.g. two) TRPs of a cell, the UE generally has multiple (e.g. two) panels, each of which is used to transmit UL signal to a different TRP. This can be referred to as multi-panel multi-TRP scenario.

In multi-panel (e.g. two panels: panel #1 and panel #2) multi-TRP (e.g. two TRPs: TRP #1 and TRP #2) scenario, two TA values shall be maintained for two links between UE and two TRPs, e.g. link #1 between panel #1 and TRP #1, and link #2 between panel #2 and TRP #2.

In a scenario that one link (e.g. link #1) is synchronized (e.g. one TA value is valid for link #1) while another link (e.g. link #2) is un-synchronized (e.g. another TA value is invalid for link #2), it is necessary to specify when the un-synchronized link (e.g. link #2) should be synchronized and how the un-synchronized link is synchronized (e.g. how the TA value for the un-synchronized link is maintained or updated).

This invention targets handling TA in multi-panel TX scenario, especially when at least one link is synchronized and at least one link is un-synchronized.

### BRIEF SUMMARY

Methods and apparatuses for handling timing advance in multi-panel TX scenario are disclosed.

In one embodiment, a UE comprises multiple links to a network device, each link is associated with a TA, wherein at least one link is un-synchronized and at least one other link is synchronized, the UE comprises a processor; and a transceiver coupled to the processor, wherein the processor is configured to: determine to update the TA for one of the at least one un-synchronized link with the network device; and transmit, via the transceiver, to the network device a request to update the TA for the one un-synchronized link.

In one embodiment, the processor is further configured to monitor an indication received from the network device to update the TA for the one un-synchronized link, and the processor is configured to determine to update the TA for the one un-synchronized link in response to the indication of updating the TA for the one un-synchronized link being received from the network device via the transceiver.

In another embodiment, the processor is configured to determine to update TA for the one un-synchronized link upon or after an expiry of the TA timer (TAT) for the one un-synchronized link, or in response to a configured threshold related to the synchronized link(s) being reached, or in response to information related to the one un-synchronized link triggering the update of the TA, or in response to information related to the synchronized link(s) or related to the synchronized link(s) and the one un-synchronized link triggering the update of the TA. In some embodiment, it is up to UE implementation to determine when to update TA for the one un-synchronized link.

In some embodiment, the request is (1) an indication of a preamble or preamble index and/or Random Access Resource or (2) some specific index or some specific index on some specific resource. The request may further contain an indication of the link for which the TA is updated.

In some embodiment, the processor is further configured to receive, via the transceiver, a response to the request from the network device, and transmit, via the transceiver, to the network device, an indicated specific index on scheduled resource on the one un-synchronized link, or initiate, via the transceiver, a Random Access Channel (RACH) procedure.

In another embodiment, a method performed by a UE comprises multiple links to a network device, each link is associated with a TA, wherein at least one link is un-synchronized and at least one other link is synchronized. The method comprises determining to update the TA for one of the at least one un-synchronized link with the network device; and transmitting to the network device a request to update the TA for the one un-synchronized link.

In yet another embodiment, a network device comprises has multiple links to a UE, each link being associated with a time alignment (TA), where at least one link is un-synchronized and at least one other link is synchronized. The network device comprises a processor; and a transceiver coupled to the processor, wherein the processor is configured to: transmit, via the transceiver, to the UE an indication to update TA for one of at least one un-synchronized link; and receive, via the transceiver, from the UE, a request to update the TA for the one un-synchronized link.

In one embodiment, the processor is configured to transmit the indication in response to the TA being invalid for the one un-synchronized link, or in response to data to be transmitted on the un-synchronized link, or in response to received information related to the one un-synchronized link reaching a threshold.

In some embodiment, the processor is further configured to transmit, via the transceiver, to the UE a response to the request to update the TA for the one un-synchronized link.

In further embodiment, a method performed by a network device comprises multiple links to a UE, each link has a TA, where at least one link is un-synchronized and the other link(s) is/are synchronized. The method comprises transmitting to the UE an indication to update TA for one of at least one un-synchronized link; and receiving from the UE a request to update the TA for the one un-synchronized link.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 is a schematic flow chart diagram illustrating an embodiment of a method;

FIG. 2 is a schematic flow chart diagram illustrating a further embodiment of a method; and

FIG. 3 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE, 3GPP NR-U, NR Radio Access operating with shared spectrum channel access and so on. It is contemplated that along with the developments of network architectures and new service scenarios, all embodiments in the present application are also applicable to similar technical problems. Moreover, the terminologies recited in the present application may change, which should not affect the principle of the present application. Embodiments of the present disclosure can also be applied to unlicensed spectrum scenario.

To make description clearer, a few concepts are clarified.

TA mentioned in this application refers to time alignment or timing advance or timing adjustment, while TA value in this application (e.g. TA #1 or TA #2) refers to the amount of TA. Generally, TA and TA value can be interchangeable.

A TA timer (TAT) (e.g. timeAlignmentTimer) is configured by RRC signaling per TA. Before the TAT of a TA expires, the TA is valid. When the TAT of a TA expires, the TA (or TA value) becomes invalid. The invalid TA needs to be updated.

“Multi-TRP” means that a serving cell can have multiple (e.g. two) TRPs. “Multi-panel” means that a UE can have multiple (e.g. two) panels. In the condition that a UE with two panels (e.g. panel #1 and panel #2) transmits UL signal (PUCCH and/or PUSCH transmissions) to a serving cell with two TRPs (e.g. TRP #1 and TRP #2), the UE may use one panel (e.g. panel #1) to transmit UL signal to one TRP (e.g. TRP #1) of the serving cell and use the other panel (e.g. panel #2) to transmit UL signal to another TRP (e.g. TRP #2) of the serving cell.

A link can be indicated as from a panel to a TRP. Since a particular panel (e.g. panel #1) is used to transmit UL signal to a particular TRP (e.g. TRP #1), a link may be indicated by a panel or a TRP. Similarly, a panel or a TRP can be indicated by a link.

Multiple beams are sent from a panel. In addition, multiple beams used for receiving belong to a TRP. Accordingly, a beam or a beam set (or beam group) consisting of multiple beams may alternatively indicate a panel, and accordingly indicate a TRP or a link.

A panel corresponds to a set of reference signals (RSs) (maybe referred to as RS set). So, an RS set may alternatively indicate a panel, and accordingly indicate a TRP or a link.

A TRP corresponds to a pool of CORESETs with the same CORESETPoolIndex. So, a CORESET pool may alternatively indicate a TRP, and accordingly indicate a link or a panel.

Each of the above-identified items to indicate a link or a panel or TRP (e.g. panel, TRP, link, beam, beam set, RS set, CORESET pool) may have an index (or ID), which means that the ID of each of the above-identified items may alternatively indicate a link or a panel or TRP.

TA can be identified per link, e.g. TA of a link (or TA associated with a link). In addition, TA of a link can be described as TA of each of the above-identified items or IDs thereof (e.g. TA of a panel, TA of a TRP, TA of a link ID . . . , etc). Incidentally, TA of a link can be also expressed as TA of a UL transmission.

In order to simplify explanation, in the following description, TA of a link (or TA associated with a link) is used.

According to this disclosure, in multi-TRP operation, multiple links (e.g. two links) are present between a UE and the gNB. For example, link #1 is between panel #1 of the UE and TRP #1 of the gNB; and link #2 is between panel #2 of the UE and TRP #2 of the gNB. The gNB may manage multiple cells. For simplification, it is assumed that TRP #1 and TRP #2 belong to the same cell, e.g. the serving cell. At least one link is synchronized (i.e. TA of each of the at least one link is valid), and the other link(s) is/are un-synchronized or non-synchronized (i.e. TA of each of the other link(s) is invalid). In other words, there is at least one synchronized link and there is at least one un-synchronized (or non-synchronized) link. Incidentally, the expression “un-synchronized” and “non-synchronized” have the same meaning. In the following description “un-synchronized” is used. For simplicity, two TRPs and two links (e.g. link #1 and link #2) are assumed. That is, one link (e.g. link #1) is synchronized (i.e. TA (e.g. TA #1) of link #1 is valid); and another link (e.g. link #2) is un-synchronized (i.e. TA (e.g. TA #2) of link #2 is invalid).

The link that is un-synchronized (e.g. link #2) needs to be synchronized (i.e. the TA of link #2 that is invalid needs to be updated), since data can only be transmitted on the synchronized link.

As a matter of fact, in some conditions, the un-synchronized link can remain un-synchronized. For example, when there is no data to be transmitted on the un-synchronized link, the un-synchronized link can remain un-synchronized. So, the first step to synchronize an un-synchronized link (i.e. update the TA of the un-synchronized link) is to determine when the synchronization of the un-synchronized link shall be made (i.e. determine to update the TA for the un-synchronized link).

According to a first embodiment, the network side, i.e. the base station (e.g. gNB), determines when the synchronization of the un-synchronized link shall be made (i.e. determine to update the TA for the un-synchronized link).

In a first sub-embodiment of the first embodiment, the gNB may determine a link shall be synchronized when (“when” means “upon or after”) the link becomes an un-synchronized link (TA of the link becomes invalid), e.g. upon or after the TAT of the link expires. The gNB knows when the TA of a link become invalid (i.e. the link is out of UL synchronization, or the link is un-synchronized) since the gNB maintains TAT of each link. So, upon or after the link becomes un-synchronized (e.g. the TAT of the link expires), the gNB determines the un-synchronized link shall be synchronized.

In a second sub-embodiment of the first embodiment, the gNB may determine an un-synchronized link shall be synchronized in response to there is data to be transmitted on the un-synchronized link. When there is no data transmission on the un-synchronized link, the un-synchronized link can remain un-synchronized. Accordingly, when the link becomes an un-synchronized link (e.g. the TAT of a link expires), the gNB does not determine that the un-synchronized link shall be synchronized. Instead, in response to there is data to be transmitted (e.g. on the un-synchronized link), the gNB determines that the un-synchronized link shall be synchronized.

In a third sub-embodiment of the first embodiment, the gNB may determine an un-synchronized link shall be synchronized according to information received from the UE, in particular, according to a comparison between the information received from the UE and a threshold (or triggered by the information received from the UE reaching a threshold).

The information may be data size, power headroom (PHR), the number of retransmissions, and/or estimated power for the UL transmission (or estimated power for the UL transmission on the synchronized link), etc. For example, if the data size is equal to or larger than threshold #1, it may not achieve a good performance to transmit the data via only the synchronized link. If the PHR (e.g. on the serving cell or on the synchronized link of the serving cell) is equal to or less than threshold #2, the performance of transmitting the data (e.g. reliability) via only the synchronized link is low. If the number of retransmissions is equal to or larger than threshold #3, the reliability of transmitting the data is low and the latency of transmitting the data is large. The gNB may calculate the UE's estimated power for the UL transmission as the difference between the nominal UE maximum transmit power and the corresponding PH value. If the calculated result is equal to or larger than threshold #4, the reliability of transmitting the data is low and the latency of transmitting the data is large. In all of above-described situations, the un-synchronized link is necessary to be synchronized so that both links can be used to transmit the data.

Accordingly, if the received information reaches a threshold (e.g. the data size is equal to or larger than a threshold (e.g. threshold #1), the PHR is equal to or less than a threshold (e.g. threshold #2), the number of retransmissions is equal to or larger than a threshold (e.g. threshold #3) and/or the estimated power for the UL transmission is equal to or larger than a threshold (e.g. threshold #4)), the gNB may determine the un-synchronized link shall be synchronized.

When the gNB determines that the un-synchronized link shall be synchronized (i.e. the TA for the un-synchronized link shall be updated), an indication is transmitted (or triggered) from the gNB to the UE. The indication may be used to indicate the UE to obtain the TA for the un-synchronized link. For example, the indication is to make the UE initiate a RACH (including contention-free RACH and contention-based RACH) or transmit, on the un-synchronized link, some specific index on some resource (e.g. some specific resource). The indication can be a PDCCH order or a new signaling or a new MAC CE from the gNB. Incidentally, the signaling transmitted in MAC CE can be multiplexed with DL data to reduce signaling overhead. If there is more than one un-synchronized link, the indication also indicates the un-synchronized link for which to obtain the TA.

In order to receive the indication of determining that an un-synchronized link shall be synchronized, the UE monitors the earliest or any PDCCH occasion, or the PDCCH associated with the un-synchronized link for RAR or TA command, so that the indication of determining that an un-synchronized link shall be synchronized will be received.

According to a second embodiment, the UE determines when the synchronization of the un-synchronized link (i.e. the update of the TA of the un-synchronized link) shall be made.

According to a first sub-embodiment of the second embodiment, the UE determines to obtain the TA for a link (un-synchronized link) once the TA for the link becomes invalid, e.g. the TAT for the link expires. When the TA for a link becomes invalid, the link becomes an un-synchronized link. The UE determines to obtain the TA for the un-synchronized link immediately.

According to a second sub-embodiment of the second embodiment, a threshold related to the synchronized link is configured, and when the threshold is reached, the UE determines to obtain the TA for the un-synchronized link.

The examples of the threshold may be data size (or data volume) on the synchronized link (e.g. threshold #1), power headroom on the synchronized link (e.g. threshold #2), the number of retransmissions (e.g. threshold #3), and/or estimated power for the UL transmission on the synchronized link (e.g. threshold #4), etc.

In the example of threshold #1 that is used to be compared with data size (or data volume) on the synchronized link, if the data volume (or data size) on the synchronized link is equal to or larger than threshold #1, the UE determines to obtain the TA for the un-synchronized link.

In the example of threshold #2 that is used to be compared with power headroom on the synchronized link, if the power headroom on the synchronized link is equal to or less than threshold #2, the UE determines to obtain the TA for the un-synchronized link.

In the example of threshold #3 that is used to be compared with the number of retransmissions (e.g. the number of HARQ retransmissions, or the number of RLC retransmissions), if the number of retransmissions is equal to or larger than threshold #3, the UE determines to obtain the TA for the un-synchronized link.

In the example of threshold #4 that is used to be compared with estimated power for the UL transmission on the synchronized link, if the estimated power for the UL transmission on the synchronized link is equal to or larger than threshold #4, the UE determines to obtain the TA for the un-synchronized link.

According to a third sub-embodiment of the second embodiment, information related to the un-synchronized link triggers the update of the TA for the un-synchronized link (i.e. synchronizing the un-synchronized link). Suppose when a link becomes an un-synchronized link (e.g. when TAT of the link expires), the resources associated with the un-synchronized are maintained or suspended, the information related to the the un-synchronized link may trigger the update of the TA for the un-synchronized link (i.e. synchronizing the un-synchronized link).

The examples of information related to the the un-synchronized link that can trigger the update of the TA for the un-synchronized link can be at least one of the following (1) to (5):

(1) UL and/or DL data arrival associated with the un-synchronized link; or SP-CSI reporting is triggered associated with the un-synchronized link; or SR is triggered associated with the un-synchronized link.

(2) the UL arrived data corresponding to the logical channel that is set to allow to be transmitted on the configured grant(s) by configuring mapping restrictions for the logical channel and the configured grant is associated with the unsynchronized link.

(3) the DL data is transmitted on the configured downlink assignments or is scheduled on the resource associated with the TRP that is associated with the un-synchronized UL link.

(4) the semi-persistent CSI reporting is activated and the PUSCH resource for semi-persistent CSI reporting is associated with the un-synchronized link.

(5) the SR configuration for the triggered SR corresponding to a logical channel is configured to associate with the un-synchronized UL link.

According to a fourth sub-embodiment of the second embodiment, information related to the the un-synchronized link and/or the synchronized link triggers the update of the TA for the un-synchronized link (i.e. synchronizing the un-synchronized link). Examples of the information related to the the un-synchronized link and/or the synchronized link can be at least one of the following (1) to (7):

(1) UL and/or DL data arrival (which may be associated with either the un-synchronized link or the synchronized link or any of the links).

(2) UL and/or DL data arrival for new transmission (which may be associated with either the un-synchronized link or the synchronized link or any of the links).

(3) The data arrival for a specific PDB configuration; or the configured PDB equal to or less than a threshold; or a specific prioritisedBitRate (PBR) configuration; or the configured PBR equal to or larger than a threshold; or the service requiring a latency less than a threshold.

(4) The data arrival for a specific or configured or pre-defined RB; or the setup of a DRB with specific configuration (e.g. a DRB associated or configured with “survival time”).

(5) The UL and/or DL data arrival for a DRB marked with an urgent or “survival time” state or entering “survival time” state.

(6) The transmission resource is associated with the unsynchronized link or associated with any link.

(7) Beam failure is detected on the TRP associated with the synchronized link. The BFR (Beam Failure Recovery) is triggered, or a RACH is initiated. The triggered BFR can generate the BFR MAC CE. The BFR MAC CE can be transmitted during a procedure of updating the TA for the un-synchronized link via the previously un-synchronized link, or the BFR MAC CE can initiate a RACH on the un-synchronized link. If the RACH is initiated by the beam failure, the initiated RACH can be performed via the previously un-synchronized link.

According to a fifth sub-embodiment of the second embodiment, it is up to UE implementation to determine when the TA shall be updated for the un-synchronized link.

After the synchronization of the un-synchronized link (i.e. the update of the TA for the un-synchronized link) is determined, the next issue is how to synchronize the un-synchronized link (i.e. how to update of the TA for the un-synchronized link).

A third embodiment relates to UE synchronizing the un-synchronized link.

Upon UE determining that the synchronization of the un-synchronized link is to be made, for example, receiving an indication of determining that an un-synchronized link shall be synchronized from the gNB according to the first embodiment, or determining that the synchronization of the un-synchronized link is to be made by the UE according to the second embodiment, the UE performs the synchronization of the un-synchronized link.

The UE performs the synchronization of the un-synchronized link by sending, to gNB, a request to obtain the TA for the un-synchronized link via the synchronized link. The request can be (1) an indication of a preamble or preamble index and/or Random Access Resource or (2) some specific index (or some specific index on some specific resource). The preamble or preamble index and/or Random Access Resource can be contention-free or contention based. Additionally, the request may additionally contain an indication (e.g. the link ID and the cell ID) for indicating the un-synchronized link for which the TA is updated.

If a response to the request (e.g. an HARQ ACK or a MAC CE or a RRC response) is received from the gNB, the UE will follow the indication from the gNB, e.g. transmit the indicated specific index on the gNB scheduled resource on the un-synchronized link, or initiate a RACH.

In particular, if the response is to the indicated preamble or preamble index and/or Random Access Resource (possibly and the link ID and cell ID), the UE will initiate a RACH with the indicated RA resource on the un-synchronized link. If no response is received for the indicated preamble or preamble index and/or Random Access Resource, the UE will initiate a RACH.

If response is to the indicated specific index (or the indicated specific index on some specific resource) (possibly and the link ID and cell ID), the UE will transmit the indicated specific index on the gNB scheduled resource on the un-synchronized link. If no response for the indicated specific index (or the indicated specific index on some specific resource) is received, for example, the gNB responds with another index or another resource, the UE will follow the indication from the gNB. If a rejection (e.g. a MAC CE or a PDCCH order or a RRC message) to the indicated specific index is received from the gNB, the UE will initiate a RACH.

FIG. 1 is a schematic flow chart diagram illustrating an embodiment of a method 500 according to the present application. In some embodiments, the method 100 is performed by an apparatus, such as a remote unit (UE). In certain embodiments, the method 100 may be performed by a processor executing program code, for example, a microcontroller, a microprocessor, a CPU, a GPU, an auxiliary processing unit, a FPGA, or the like.

The method 100 may be performed by a UE, the UE has multiple links to a network device, each link is associated with a TA, wherein at least one link is un-synchronized and at least one other link is synchronized. The method 100 comprises 110 determining to update the TA for one of the at least one un-synchronized link with the network device; and 120 transmitting to the network device a request to update the TA for the one un-synchronized link.

In one embodiment, the method further comprises monitoring an indication received from the network device to update the TA for the one un-synchronized link, and determining to update the TA for the one un-synchronized link in response to the indication of updating the TA for the one un-synchronized link being received from the network device.

In another embodiment, the method further comprise determining to update TA for the one un-synchronized link, upon or after an expiry of the TA timer (TAT) for the one un-synchronized link, or in response to a configured threshold related to the synchronized link(s) being reached, or in response to information related to the one un-synchronized link triggering the update of the TA, or in response to information related to the synchronized link(s) or related to the synchronized link(s) and the one un-synchronized link triggering the update of the TA. In some embodiment, it is up to UE implementation to determine when to update TA for the one un-synchronized link.

In some embodiment, the request is (1) an indication of a preamble or preamble index and/or Random Access Resource or (2) some specific index or some specific index on some specific resource. The request may further contain an indication of the link for which the TA is updated.

In some embodiment, the method further comprises receiving a response to the request from the network device, and transmitting to the network device an indicated specific index on scheduled resource on the one un-synchronized link, or initiate a Random Access Channel (RACH) procedure.

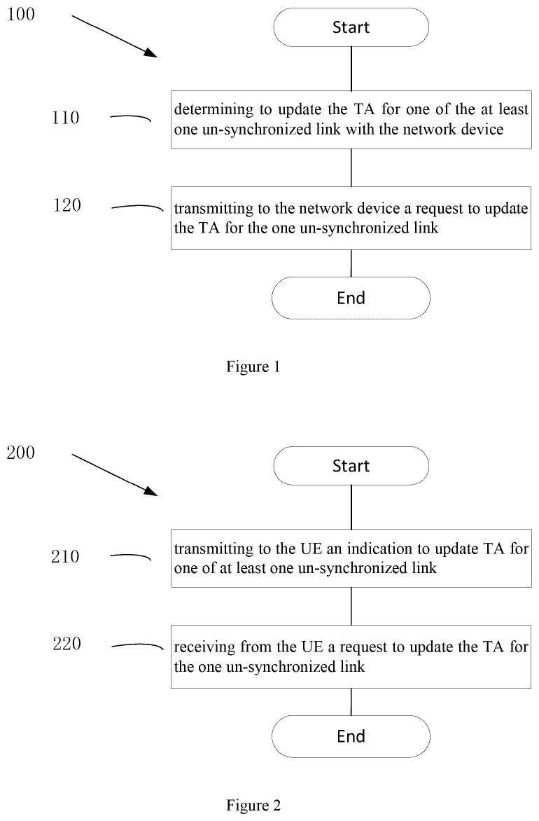

FIG. 2 is a schematic flow chart diagram illustrating a further embodiment of a method 200 according to the present application. In some embodiments, the method 200 is performed by an apparatus, such as a base unit or a network device. In certain embodiments, the method 200 may be performed by a processor executing program code, for example, a microcontroller, a microprocessor, a CPU, a GPU, an auxiliary processing unit, a FPGA, or the like.

The method 200 may be performed by a network device, the network device has multiple links to a UE, each link has a TA, where at least one link is un-synchronized and at least one other link is synchronized. The method 200 comprises 210 transmitting to the UE an indication to update TA for one of at least one un-synchronized link; and 220 receiving from the UE a request to update the TA for the one un-synchronized link.

In one embodiment, the indication is transmitted in response to the TA being invalid for the one un-synchronized link, or in response to data to be transmitted on the un-synchronized link, or in response to received information related to the one un-synchronized link reaching a threshold.

In some embodiment, the method further comprises transmitting to the UE a response to the request to update the TA for the one un-synchronized link.

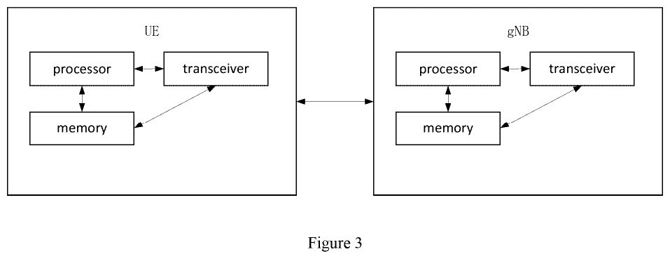

FIG. 3 is a schematic block diagram illustrating apparatuses according to one embodiment.

Referring to FIG. 3, the UE (i.e. remote unit, or terminal device) includes a processor, a memory, and a transceiver. The processor implements a function, a process, and/or a method which are proposed in FIG. 1.

The UE has multiple links to a network device, each link is associated with a TA, wherein at least one link is un-synchronized and at least one other link is synchronized, the UE comprises a processor; and a transceiver coupled to the processor, wherein the processor is configured to: determine to update the TA for one of the at least one un-synchronized link with the network device; and transmit, via the transceiver, to the network device a request to update the TA for the one un-synchronized link.

In one embodiment, the processor is further configured to monitor an indication received from the network device to update the TA for the one un-synchronized link, and the processor is configured to determine to update the TA for the one un-synchronized link in response to the indication of updating the TA for the one un-synchronized link being received from the network device via the transceiver.

In another embodiment, the processor is configured to determine to update TA for the one un-synchronized link, upon or after an expiry of the TA timer (TAT) for the one un-synchronized link, or in response to a configured threshold related to the synchronized link(s) being reached, or in response to information related to the one un-synchronized link triggering the update of the TA, or in response to information related to the synchronized link(s) or related to the synchronized link(s) and the one un-synchronized link triggering the update of the TA. In some embodiment, it is up to UE implementation to determine when to update TA for the one un-synchronized link.

In some embodiment, the request is (1) an indication of a preamble or preamble index and/or Random Access Resource or (2) some specific index or some specific index on some specific resource. The request may further contain an indication of the link for which the TA is updated.

In some embodiment, the processor is further configured to receive, via the transceiver, a response to the request from the network device, and transmit, via the transceiver, to the network device, an indicated specific index on scheduled resource on the one un-synchronized link, or initiate, via the transceiver, a Random Access Channel (RACH) procedure.

Referring to FIG. 3, the gNB (i.e. base unit or network device) has multiple links to a UE, each link being associated with a time alignment (TA), where at least one link is un-synchronized and at least one other link is synchronized. The gNB comprises a processor; and a transceiver coupled to the processor, wherein the processor is configured to: transmit, via the transceiver, to the UE an indication to update TA for one of at least one un-synchronized link; and receive, via the transceiver, from the UE, a request to update the TA for the one un-synchronized link.

In one embodiment, the processor is configured to transmit the indication in response to the TA being invalid for the one un-synchronized link, or in response to data to be transmitted on the un-synchronized link, or in response to received information related to the one un-synchronized link reaching a threshold.

In some embodiment, the processor is further configured to transmit, via the transceiver, to the UE a response to the request to update the TA for the one un-synchronized link.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A user equipment (UE) for wireless communication having multiple links to a network device, each link being associated with a time alignment (TA), wherein the multiple links include one or more synchronized links and one or more un-synchronized links, the UE comprising:
at least one memory; and
at least one processor coupled with the at least one memory and configured to cause the UE to:
determine to update the TA for at least one un-synchronized link of the one or more un-synchronized links; and
transmit a request to update the TA for the at least one un-synchronized link.

2. The UE of claim 1, wherein the at least one processor is further configured to cause the UE to: monitor an indication received from the network device to update the TA for the at least one un-synchronized link, and
update the TA for the at least one un-synchronized link in response to the indication of updating the TA for the at least one un-synchronized link being received from the network device.

3. The UE of claim 1, wherein the at least one processor is further configured to cause the UE to: determine to update the TA for the at least one un-synchronized link upon or after an expiry of a TA timer (TAT) for the at least one un-synchronized link.

4. The UE of claim 1, wherein the at least one processor is further configured to cause the UE to: determine to update the TA for the at least one un-synchronized link in response to a configured threshold related to the one or more synchronized links being reached.

5. The UE of claim 1, wherein the at least one processor is further configured to cause the UE to: determine to update the TA for the at least one un-synchronized link in response to information related to the at least one un-synchronized link triggering the update of the TA.

6. The UE of claim 1, wherein the at least one processor is further configured to cause the UE to: determine to update the TA for the at least one un-synchronized link in response to information related to the one or more synchronized links or related to the one or more synchronized links and the at least one un-synchronized link triggering the update of the TA.

7. The UE of claim 1, wherein, the request is (1) an indication of a preamble or preamble index or a Random Access Resource or (2) a specific index or a some specific index on a specific resource.

8. The UE of claim 1, wherein, the request comprises an indication of the at least one un-synchronized link for which the TA is updated.

9. The UE of claim 1, wherein, the at least one processor is further configured to cause the UE to:
receive a response to the request from the network device, and
transmit, to the network device, an indicated specific index on scheduled resource on the at least one un-synchronized link, or
initiate a Random Access Channel (RACH) procedure.

10. (canceled)

11. A network device for wireless communication having multiple links to a UE, each link being associated with a time alignment (TA), wherein the multiple links include one or more synchronized links and one or more un-synchronized links, the network device comprising:
at least one memory; and
at least one processor coupled with the at least one memory and configured to cause the network device to:
transmit to the UE an indication to update the TA for one un-synchronized link of the one or more un-synchronized links; and
receive, from the UE, a request to update the TA for at least the one un-synchronized link.

12. The network device of claim 11, wherein, the at least one processor is further configured to cause the network device to: transmit the indication to the UE in response to the TA being invalid for the at least one un-synchronized link.

13. The network device of claim 11, wherein, the at least one processor is further configured to cause the network device to: transmit the indication to the UE in response to data to be transmitted on the at least one un-synchronized link.

14. The network device of claim 11, wherein,
the at least one processor is further configured to cause the network device to: receive, from the UE, information related to the at least one un-synchronized link; and
transmit the indication to the UE in response to the information related to the at least one un-synchronized link reaching a threshold.

15. The network device of claim 11, wherein, the at least one processor is further configured to cause the network device to: transmit, to the UE, a response to the request to update the TA for the at least one un-synchronized link.

16. A method performed by a user equipment (UE) having multiple links to a network device, each link being associated with a time alignment (TA), wherein the multiple links include one or more synchronized links and one or more un-synchronized links, the method comprising:
determining to update the TA for at least one un-synchronized link of the one or more un-synchronized links; and
transmitting a request to the network device to update the TA for the at least one un-synchronized link.

17. The method of claim 16, further comprising:
monitoring an indication received from the network device to update the TA for the at least one un-synchronized link, and
updating the TA for the at least one un-synchronized link in response to the indication of updating the TA for the at least one un-synchronized link being received from the network device.

18. The method of claim 16, wherein the request is (1) an indication of a preamble or preamble index or a Random Access Resource or (2) a specific index or a some specific index on a specific resource.

19. A processor for wireless communication having multiple links to a network device, each link being associated with a time alignment (TA), wherein the multiple links include one or more synchronized links and one or more un-synchronized links, the processor comprising:
at least one controller coupled with the at least one memory and configured to cause the processor to:
determine to update the TA for at least one un-synchronized link of the one or more un-synchronized links; and
transmit a request to update the TA for the at least one un-synchronized link.

20. The processor of claim 19, wherein the at least one controller is further configured to cause the processor to: monitor an indication received from the network device to update the TA for the at least one un-synchronized link, and
update the TA for the at least one un-synchronized link in response to the indication of updating the TA for the at least one un-synchronized link being received from the network device.

21. The processor of claim 19, wherein the request is (1) an indication of a preamble or preamble index or a Random Access Resource or (2) a specific index or a some specific index on a specific resource.
